(19) United States
(12) Patent Application Publication
(10) Pub. No.: US 2016/0355220 A1
(43) Pub. Date: Dec. 8, 2016

(54) POWER PACK ASSEMBLY

(71) Applicant: Caterpillar Inc., Peoria, IL (US)

(72) Inventor: Stephen Platt Rutherford, Edwards, IL (US)

(73) Assignee: Caterpillar Inc., Peoria, IL (US)

(21) Appl. No.: 15/241,548

(22) Filed: Aug. 19, 2016

(51) Int. Cl. B62D 39/00

(52) U.S. Cl. CPC B62D 39/00

(57) ABSTRACT

A power pack assembly is provided. The power pack assembly includes a frame having a first portion and a second portion. The first portion is slidably coupled to the second portion. The power pack assembly includes a power source provided on the first portion. The power pack assembly includes a first carrier coupled to the first portion. The power pack assembly also includes a second carrier coupled to the second portion. The first carrier and the second carrier are adapted to support an implement therebetween. The power pack assembly further includes a lock mechanism provided between the first carrier and the second carrier, and the implement. The lock mechanism is adapted to removably affix the implement to the first carrier and the second carrier respectively.

### TECHNICAL FIELD

The present disclosure relates to a power pack assembly. More particularly, the present disclosure relates to the power pack assembly for an implement.

### BACKGROUND

Generally, implements including, but not limited to, a generator, a welder, an air compressor, a pressure washer, and a trash pump are employed on a work site for various activities. Such implements may require a dedicated power pack such as an engine or a motor in order to power each of these implements. Hence, a separate power pack may have to be purchased or rented for each of the individual implements.

However, during a typical work day or work cycle, each implement may be used during a specific time/duration when a desired activity may have to be carried out. As a result, the dedicated power pack accompanied with the individual implement may have to stand idle along with the individual implement when the implement may not be in use. This may result in lower utilization of the dedicated power pack, increased purchase/rental cost, and so on.

U.S. Pat. No. 8,540,272 describes a vehicle chassis. The vehicle chassis includes a vehicle chassis frame. The frame includes a first frame portion and a second frame portion operatively connected to the first frame portion. The second frame portion is selectively movable with respect to the first frame portion such that a length of the vehicle chassis is selectively variable. The chassis may thus be lengthened to support the addition of an extension unit when additional passenger space or cargo space is desired.

However, the current method does not provide improving the utilization of the power pack.

### SUMMARY OF THE DISCLOSURE

In an aspect of the present disclosure, a power pack assembly is provided. The power pack assembly includes a frame having a first portion and a second portion. The first portion is coupled to the second portion. The power pack assembly includes a power source provided on the first portion. The power pack assembly includes a first carrier coupled to the first portion. The power pack assembly also includes a second carrier coupled to the second portion. The first carrier and the second carrier are adapted to support an implement therebetween. The power pack assembly further includes a lock mechanism provided between the first carrier and the second carrier, and the implement. The lock mechanism is adapted to affix the implement to the first carrier and the second carrier respectively.

Other features and aspects of this disclosure will be apparent from the following description and the accompanying drawings.

### BRIEF DESCRIPTION OF THE DRAWINGS

FIG. 1 is a side view of an exemplary power pack, according to one concept of the present disclosure;

FIG. 2 is another side view of the power pack of FIG. 1, according to the concept of the present disclosure;

FIG. 3 is a partial cross sectional view of the power pack assembly of FIG. 1 along a section A-A′ showing a lock mechanism in a disengaged position, according to the concept of the present disclosure; and

FIG. 4 is a partial cross sectional view of the power pack assembly of FIG. 1 along the section A-A′ showing the lock mechanism of FIG. 3 in an engaged position, according to the concept of the present disclosure.

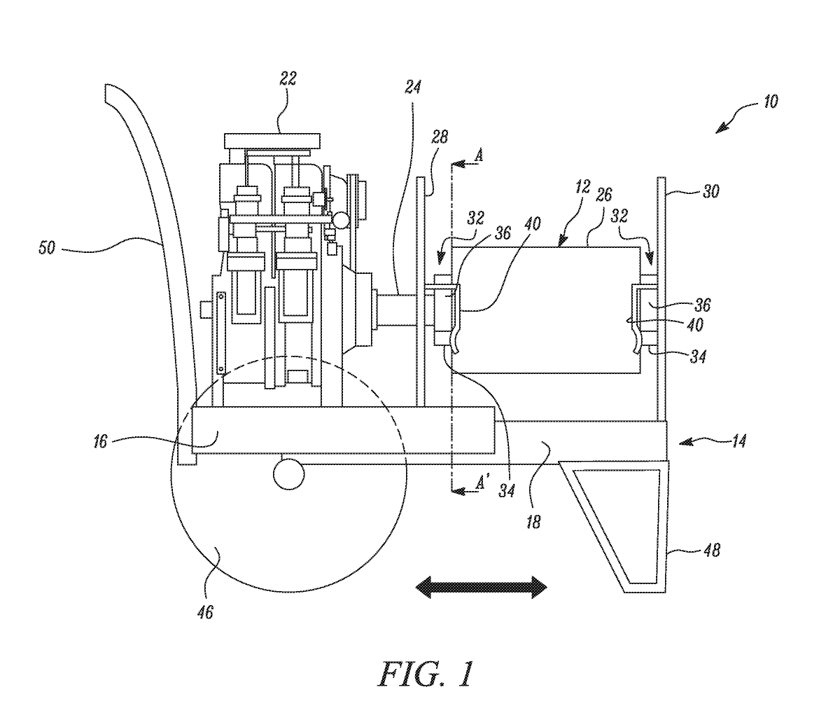

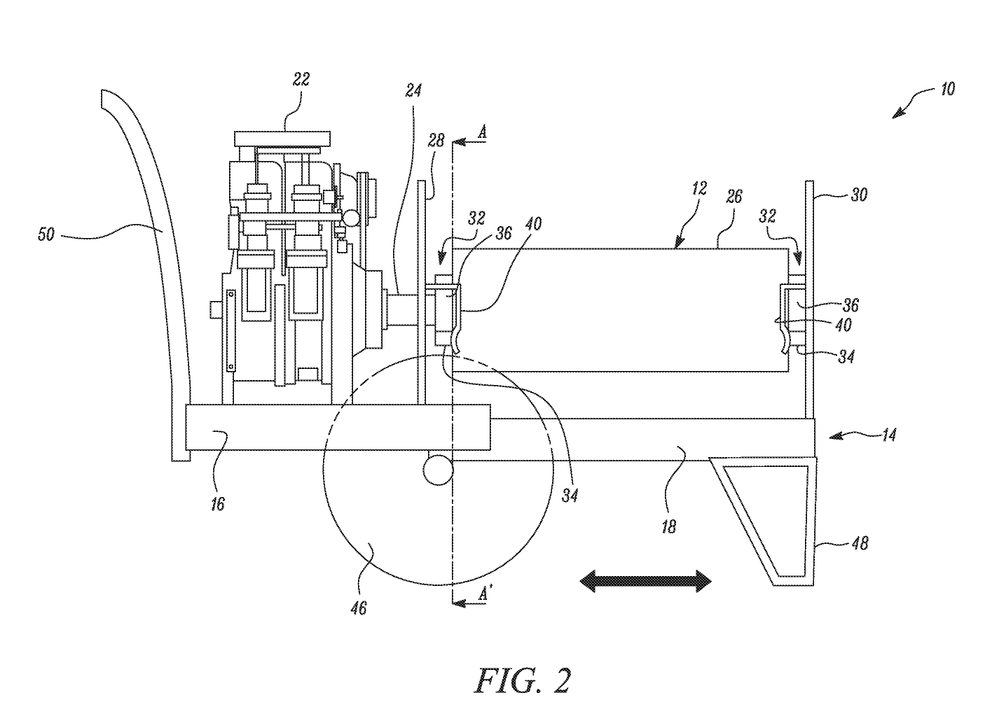

### DETAILED DESCRIPTION

Wherever possible, the same reference numbers will be used throughout the drawings to refer to the same or the like parts. Referring to FIGS. 1 and 2, an exemplary power pack assembly 10 is illustrated. The power pack assembly 10 is adapted to support and provide mechanical power to an implement 12 including, but not limited to, a generator, a welder, an air compressor, a pressure washer, and a trash pump. The power pack assembly 10 may be employed in an industry/location including, but not limited to, construction, power generation, manufacturing, service/maintenance stations, and workshops.

The power pack assembly 10 includes a frame 14. The frame 14 includes a first portion 16 and a second portion 18. The second portion 18 is slidably coupled to the first portion 16. More specifically, the second portion 18 may be slidably coupled to the first portion 16 by any slidable coupling known in the art, such as a telescopic arrangement, a rack and pinion arrangement, rollers, rails, and so on. Accordingly, the second portion 18 may translate along a longitudinal direction with respect to the first portion 16 as shown by a directional arrow.

As such, the frame 14 may include variable length based on a position of the second portion 18 with respect to the first portion 16. More specifically, as shown in FIG. 2, the second portion 18 may slide outwards with respect to the first portion 16 in order to accommodate the implement 12 having a relatively longer length. Alternatively, as shown in FIG. 1, the second portion 18 may slide inwards with respect to the first portion 16 in order to accommodate the implement 12 having a relatively shorter length.

The power pack assembly 10 includes a power source 22 provided on the first portion 16. In one embodiment, the power source 22 may be an internal combustion engine powered by any fuel such as gasoline, diesel, natural gas, and so on, or a combination thereof. In another embodiment, the power source 22 may be an electric motor powered by an external electrical power, batteries, and so on. The power source 22 is operatively coupled to the implement 12 via a drive shaft 24.

More specifically, the drive shaft 24 is coupled to a driven shaft (not shown) of the implement 12. The driven shaft is provided within a housing 26 of the implement 12. The drive shaft 24 may be coupled to the driven shaft by any known shaft coupling methods known in the art. Accordingly, the power source 22 is adapted to provide mechanical power to the implement 12 via the drive shaft 24.

The power pack assembly 10 includes a first carrier 28 coupled to the first portion 16. The first carrier 28 is disposed perpendicularly with respect to the first portion 16. The power pack assembly 10 also includes a second carrier 30 coupled to the second portion 18. The second carrier 30 is disposed perpendicularly with respect to the second portion 18.

Also, the second carrier 30 is disposed parallel and spaced apart with respect to the first carrier 28. Further, the second carrier 30 is distal with respect to the power source 22. As such, the first carrier 28 is disposed between the power source 22 and the second carrier 30. The first carrier 28 and the second carrier 30 are adapted to support the implement 12 therebetween. More specifically, the first carrier 28 and the second carrier 30 are adapted to support and lock the housing 26 of the implement 12 therebetween and will be explained in more detail later.

The power pack assembly 10 also includes a lock mechanism 32 provided between the first carrier 28 and the implement 12. Additionally, the lock mechanism 32 is also provided between the second carrier 30 and the implement 12. For the purpose of explanation, the lock mechanism 32 will now be described with respect to the first carrier 28. It should be noted that a similar arrangement of the lock mechanism 32 may be additionally provided between the second carrier 30 and the implement 12. The lock mechanism 32 is adapted to removably affix the implement 12 to at least one of the first carrier 28 and the second carrier 30 respectively.

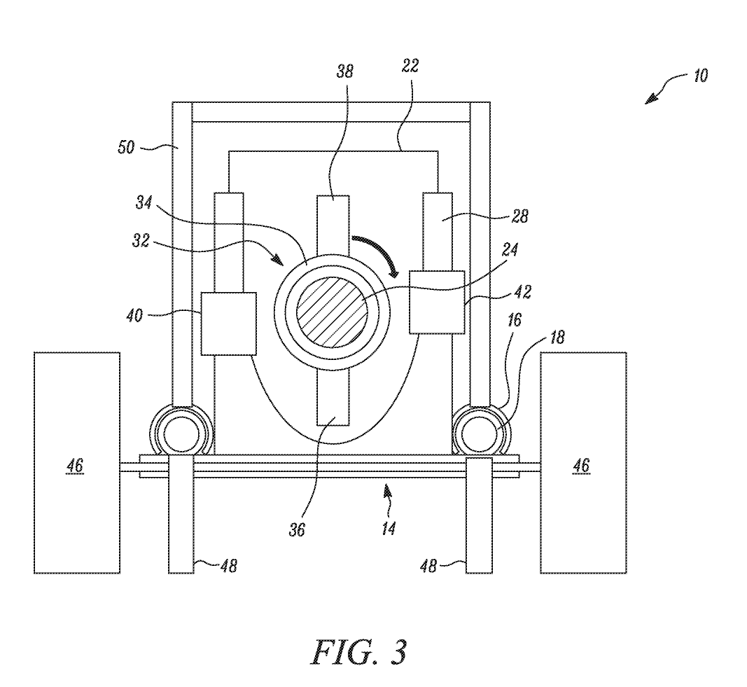

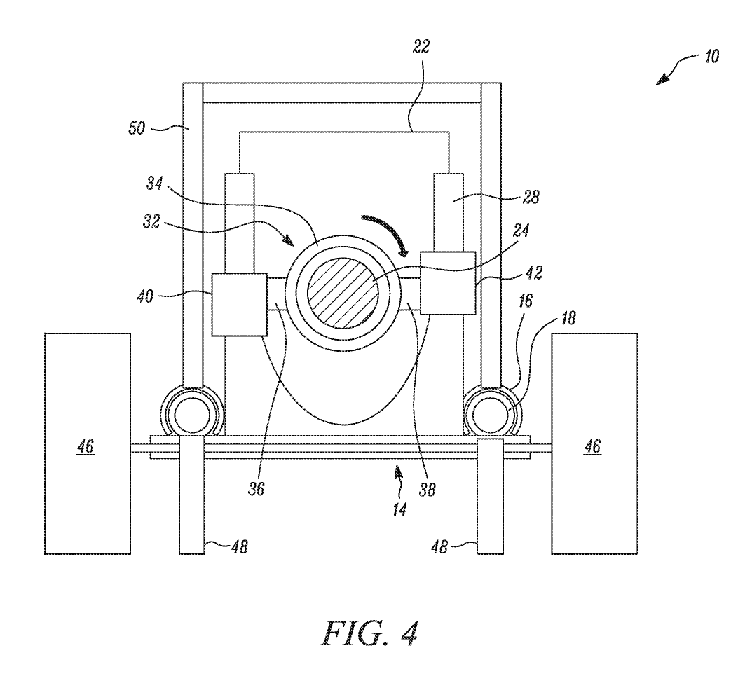

Referring to FIGS. 3 and 4, the lock mechanism 32 includes a ring 34. The ring 34 is rotatably coupled to the housing 26 of the implement 12. The drive shaft 24 of the power source 22 is received through the ring 34 in order to be coupled to the driven shaft of the implement 12. Further, the lock mechanism 32 includes a first tab 36 and a second tab 38 provided on the ring 34. The first tab 36 and the second tab 38 are provided diametrically opposite one another. In other embodiments, the ring 34 may include a single or multiple tabs provided thereon based on application requirements and without limiting the scope of the disclosure.

Additionally, the lock mechanism 32 includes a first bracket 40 and a second bracket 42 provided on the first carrier 28. The first bracket 40 is provided in association with the first tab 36. Also, the first tab 36 is oriented in a downward direction. The first tab 36 is adapted to receive and lock the first tab 36 therein. The second bracket 42 is provided in association with the second tab 38. Also, the second tab 38 is oriented in an upward direction. The second tab 38 is adapted to receive and lock the second tab 38 therein. The first bracket 40 and the second bracket 42 may include a resilient structure in order to snap lock the first tab 36 and the second tab 38 therein respectively. In other embodiments, the first bracket 40 and the second bracket 42 may include any other known method to lock the first tab 36 and the second tab 38 therein respectively.

As shown in FIG. 3, during assembly of the implement 12 on the power pack assembly 10, the ring 34 is rotated in a manner such that the first tab 36 and the second tab 38 are away from the first bracket 40 and the second bracket 42 respectively. Further, the implement 12 is arranged between the first carrier 28 and the second carrier 30. Also, the length of the frame 14 may be adjusted based on a length of the implement 12 by moving the second portion 18 with respect to the first portion 16.

Further, as the implement 12 may be held in place between the first carrier 28 and the second carrier 30, as shown in FIG. 4, the ring 34 may be rotated in a clockwise direction, as shown by a directional arrow, such that the first tab 36 is received and snapped within the first bracket 40 and the second tab 38 is received and snapped within the second bracket 42. As a result, the housing 26 of the implement 12 is coupled with respect to the first carrier 28 via the arrangement of the first tab 36, first bracket 40 and the second tab 38, second bracket 42. A similar locking mechanism is provided between the housing 26 and the second carrier 30 in order to couple the implement 12 with respect to the second carrier 30.

During disassembly of the implement 12 from the power pack assembly 10, the ring 34 may be rotated in an anticlockwise direction. Accordingly, the first tab 36 and the second tab 38 may be released from the first bracket 40 and the second bracket 42 respectively. As a result, the housing 26 of the implement 12 may be decoupled with respect to the first carrier 28.

It should be noted that the orientation of the first bracket 40 and the second bracket 42 is based on a direction of rotation of the drive shaft 24. For example, in the illustrated embodiment, the drive shaft 24 rotates in the clockwise direction as shown by the directional arrow. Accordingly, during operation, as torque may be transferred from the drive shaft 24 to the driven shaft, a portion of the torque may be transferred to the housing 26 of the implement 12.

As a result, the housing 26 may also tend to rotate in the clockwise direction. Further, the torque may be transferred via the ring 34 to the first tab 36 and the second tab 38 in turn securely locking the first tab 36 and the second tab 38 within the first bracket 40 and the second bracket 42 respectively. Accordingly, the arrangement of the first tab 36, the first bracket 40, and the second tab 38, the second bracket 42 counteracts the torque experienced by the housing 26. In other embodiments when the drive shaft 24/driven shaft/housing 26 may rotate in the anticlockwise direction, the first bracket 40 may be oriented in the upward direction and the second bracket 42 may be oriented in the downward direction.

The power pack assembly 10 includes a set of wheels 46 coupled to the second portion 18. For the purpose of clarity, only one wheel 46 is shown coupled to the second portion 18 in FIGS. 1 and 2. In another embodiment, the power pack assembly 10 may include a single wheel 46 coupled to the second portion 18. Alternatively, the wheels 46 may be coupled to the first portion 16.

In other embodiments, the power pack assembly 10 may include two sets of wheels (not shown) such that a first set of wheels may be coupled to the first portion 16 and a second set of wheels may be coupled to the second portion 18. In yet other embodiments, the power pack assembly 10 may include multiple wheels 46 coupled to the first portion 16 and/or the second portion 18. In the illustrated embodiment, the wheels 46 are disposed distally with respect to the second carrier 30. The wheels 46 are adapted to provide support and mobility to the power pack assembly 10 on ground.

The power pack assembly 10 also includes a protrusion 48 extending from the second portion 18 of the frame 14. The protrusion 48 is disposed distally with respect to the wheels 46. In the embodiment when the wheels 46 may be coupled to the second portion 18, the protrusion 48 may be provided extending from the first portion 16. Also, in the embodiment when the wheels 46 may be provided coupled to both the first portion 16 and the second portion 18, the protrusion 48 may be omitted. The protrusion 48 is adapted to support the power pack assembly 10 on the ground when the power pack assembly 10 may be stationary.

Additionally, the power pack assembly 10 includes an arm 50 coupled to the first portion 16 of the frame 14. Alternatively, the arm 50 may be coupled to any other location on the frame 14 such as the second portion 18. The arm 50 is adapted to steer the power pack assembly 10 on the ground.

### INDUSTRIAL APPLICABILITY

The present disclosure relates to the power pack assembly 10 for the implement 12. The power pack assembly 10 includes the frame 14 having the first portion 16 and the second portion 18. The second portion 18 may be adjusted with respect to the first portion 16 in order to accommodate different implements 12 having varied lengths. Also, the wheels 46 are coupled to the second portion 18 of the frame 14. As a result, when the second portion 18 may be adjusted with respect to the first portion 16, the wheels 46 may also move with respect to the first portion 16 in turn improving an overall balance of the power pack assembly 10.

Further, the lock mechanism 32 provides ease of coupling and decoupling of the implement 12 to the first carrier 28 and/or the second carrier 30. Also, the lock mechanism 32 provides transfer of load of the implement 12 therethrough to the frame 14. In situations when the implement 12 may rest on the frame 14, the lock mechanism 32 may provide additional coupling of the housing 26 of the implement 12 to the first carrier 28 and/or the second carrier 30.

The power pack assembly 10 provides a simple, efficient, and versatile method to selectively power different implements 12 with the single power source 22. As a result, single power pack assembly 10 may be employed on a worksite in order to power multiple implements 12 selectively based on application requirements. The power pack assembly 10 thus provides to improve utilization, efficiency, and so on of the power source 22 by powering multiple implements 12 with the single power source 22. The power pack assembly 10 also provides to reduce purchase/rental cost, maintenance, and so on that may be incurred for multiple power packs employed on the worksite.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of the disclosure. Such embodiments should be understood to fall within the scope of the present disclosure as determined based upon the claims and any equivalents thereof.

What is claimed is:

1. A power pack assembly comprising:
a frame including a first portion and a second portion, the first portion slidably coupled to the second portion;
a power source provided on the first portion;
a first carrier coupled to the first portion;
a second carrier coupled to the second portion, the first carrier and the second carrier adapted to support an implement therebetween; and
a lock mechanism provided between at least one of the first carrier and the second carrier, and the implement, the lock mechanism adapted to removably affix the implement to at least one of the first carrier and the second carrier respectively.

2. The power pack assembly of claim 1, wherein the lock mechanism includes a tab provided on the implement, the tab adapted to engage a bracket provided on at least one of the first carrier and the second carrier.

3. The power pack assembly of claim 1 further includes a wheel coupled to the second portion of the frame.

4. The power pack assembly of claim 3 further includes a protrusion extending from the second portion of the frame, the protrusion disposed distally with respect to the wheel.

5. The power pack assembly of claim 1 further includes an arm coupled to the first portion of the frame.

6. The power pack assembly of claim 1, wherein the power source is operably coupled to the implement.
